(19) United States
(12) Patent Application Publication
(10) Pub. No.: US 2018/0255486 A1
(43) Pub. Date: Sep. 6, 2018

(54) ADAPTIVELY SUPPLEMENTING WLAN THROUGHPUT WITH WWAN DATA

(71) Applicant: QUALCOMM Incorporated, San Diego, CA (US)

(72) Inventors: Mukesh Kumar, Hyderabad (IN); Anand Rajurkar, Hyderabad (IN); Suresh Sanka, Hyderabad (IN); Sivasubramanian Ramalingam, Hyderabad (IN); Vishnu Namboodiri Karakkad Kesavan Namboodiri, Hyderabad (IN)

(21) Appl. No.: 15/446,925

(22) Filed: Mar. 1, 2017

(51) Int. Cl. H04W 36/00; H04L 12/729

(52) U.S. Cl. CPC H04W 36/0022; H04W 84/12; H04L 45/125

(57) ABSTRACT

Examples described herein relate to supplementing wireless local area network (WLAN) connection of a wireless having multiple Subscriber Identity Modules (SIMs) in which at least one of the SIMs is associated with a Designated Data Service (DDS) subscription. A method includes connecting the wireless communication device with a wireless local area network (WLAN), receiving a request for transferring data, determining whether a WLAN link rate of the wireless communication device is less than a link rate threshold, transferring the data over the WLAN in response to determining that the WLAN link rate is not less than the link rate threshold, and transferring a first portion of the data over the WLAN and a second portion of the data via the DDS subscription in response to determining that the WLAN link rate is less than the link rate threshold.

### BACKGROUND

A wireless communication device, such as a mobile phone device or a smart phone, may include two or more Subscriber Identity Modules (SIMs). Each SIM may correspond to at least one subscription via one or more Radio Access Technologies (RATs). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

Recently, wireless local area network (WLAN) (e.g., Wi-Fi) is widely deployed by wireless communication devices equipped with WLAN connecting capability. WLAN may operate in various settings, such as but not limited to, a residential setting as a home Wi-Fi network, a commercial/retail setting as a Wi-Fi hotspot, or a business/office setting as an enterprise Wi-Fi network. Because data usage on WLAN has a relatively low cost compared to data usage on mobile networks (e.g., 2G, 3G, 4G, 5G), a wireless communication device may prioritize WLAN over mobile networks for data services when both are available. However, the speed of WLAN may not be optimal when the wireless communication device is located at the edge of the WLAN coverage area, when more devices are connected to the WLAN network, and/or when signal interferences are present, and so on. User experience (e.g., webpage browsing experience) may be poor when WLAN performance degrades. Thus, it is desirable to enhance user experience and take advantage of both WLAN and mobile networks.

### SUMMARY

Examples described herein relate to apparatuses and methods for adaptively supplementing WLAN throughput with WWAN data for a wireless communication device. The wireless communication device has multiple SIMs in which at least one of the SIMs is associated with a Designated Data Service (DDS) subscription.

According to some examples, the method comprises connecting the wireless communication device with a WLAN, receiving a request for transferring data, determining whether a WLAN link rate of the wireless communication device is less than a link rate threshold, and transferring a first portion of the data over the WLAN and a second portion of the data via the DDS subscription in response to determining that the WLAN link rate is less than the link rate threshold.

In some examples, the method further comprises transferring the data over the WLAN in response to determining that the WLAN link is not less than the link rate threshold.

In some examples, the WLAN is a Wi-Fi network, a Bluetooth network, or a WiMAX network.

In some examples, the link rate threshold is predefined.

In some examples, the link rate threshold varies with a size of the data requested for transferring.

In some examples, the method further comprises passively monitoring a data throughput at a WLAN interface of the wireless communication device during a period of time, and determining the WLAN link rate based on the monitored data throughput during the period of time.

In some examples, the method further comprises opening one or more connections on the WLAN, transferring the first portion of data through the one or more connections opened on the WLAN, opening one or more parallel connections on the DDS subscription, and transferring the second portion of data through the one or more parallel connections opened on the DDS subscription.

In some examples, the first portion of data and the second portion of data are so arranged that a sum of the WLAN link rate and a link rate of the DDS subscription crosses the link rate threshold.

According to some examples, a method comprises connecting the wireless communication device with a WLAN, registering a circuit switched (CS) domain for the DDS subscription but not a packet switched (PS) domain in response to the connecting, receiving a request for transferring data, determining whether a WLAN link rate of the wireless communication device is less than a link rate threshold, registering the PS domain for the DDS subscription in response to determining that the WLAN link rate is less than the link rate threshold, and transferring a first portion of the data over the WLAN and a second portion of the data via the DDS subscription.

In some examples, the method further comprises transferring the data over the WLAN in response to determining that the WLAN link is not less than the link rate threshold.

In some examples, the method further comprises passively monitoring a data throughput at a WLAN interface of the wireless communication device during a period of time, and determining the WLAN link rate based on the monitored data throughput during the period of time.

In some examples, the method further comprises opening one or more connections on the WLAN, transferring the first portion of data through the one or more connections opened on the WLAN, opening one or more parallel connections on the DDS subscription, and transferring the second portion of data through the one or more parallel connections opened on the DDS subscription.

In some examples, the first portion of data and the second portion of data are so arranged that a sum of the WLAN link rate and a link rate of the DDS subscription crosses the link rate threshold.

In some examples, the link rate threshold is predefined.

According to some examples, a wireless communication device comprises multiple SIMs in which at least one of the SIMs is associated with a DDS subscription. The wireless communication device also comprises a WLAN interface, a memory configured to store a link rate threshold, and a processor coupled to the multiple SIMS, the WLAN interface, and the memory. The processor is configured to connect the wireless communication device with a WLAN through the WLAN interface, receive a request for transferring data, determine whether a WLAN link rate of the wireless communication device is less than the link rate threshold, and transfer a first portion of the data over the WLAN and a second portion of the data via the DDS subscription in response to determining that the WLAN link rate is less than the link rate threshold.

In some examples, the processor is further configured to transfer the data over the WLAN in response to determining that the WLAN link is not less than the link rate threshold.

In some examples, the WLAN is a Wi-Fi network, a Bluetooth network, or a WiMAX network.

In some examples, the link rate threshold is predefined.

In some examples, the link rate threshold varies with a size of the data requested for transferring.

In some examples, the processor is further configured to passively monitor a data throughput transmitted and/or received at the WLAN interface during a period of time, and determine the WLAN link rate based on the monitored data throughput during the period of time.

In some examples, the processor is further configured to open one or more connections on the WLAN, transfer the first portion of data through the one or more connections opened on the WLAN, open one or more parallel connections on the DDS subscription, and transfer the second portion of data through the one or more parallel connections opened on the DDS subscription.

In some examples, the first portion of data and the second portion of data are so arranged that a sum of the WLAN link rate and a link rate of the DDS subscription crosses the link rate threshold.

In some examples, the processor is further configured to register a circuit switched (CS) domain for the DDS subscription but not a packet switched (PS) domain in response to the connecting, and register the PS domain for the DDS subscription in response to determining that the WLAN link rate is less than the link rate threshold.

In some examples, a non-transitory computer-readable medium has processor-readable instruction such that, when executed, causes a processor to perform a method for a wireless communication having multiple SIMs in which at least one of the SIMs is associated with a DDS subscription. The method comprises connecting the wireless communication device with a WLAN, receiving a request for transferring data, determining whether a WLAN link rate of the wireless communication device is less than a link rate threshold, and transferring a first portion of the data over the WLAN and a second portion of the data via the DDS subscription in response to determining that the WLAN link rate is less than the link rate threshold.

In some examples, the method further comprises transferring the data over the WLAN in response to determining that the WLAN link is not less than the link rate threshold.

In some examples, the link rate threshold is predefined.

In some examples, the method further comprises passively monitoring a data throughput transmitted and/or received at the WLAN interface during a period of time, and determining the WLAN link rate based on the monitored data throughput during the period of time.

In some examples, the method further comprises opening one or more connections on the WLAN, transferring the first portion of data through the one or more connections opened on the WLAN, opening one or more parallel connections on the DDS subscription, and transferring the second portion of data through the one or more parallel connections opened on the DDS subscription.

In some examples, the first portion of data and the second portion of data are so arranged that a sum of the WLAN link rate and a link rate of the DDS subscription crosses the link rate threshold.

In some examples, the method further comprises registering a circuit switched (CS) domain for the DDS subscription but not a packet switched (PS) domain in response to the connecting, and registering the PS domain for the DDS subscription in response to determining that the WLAN link rate is less than the link rate threshold.

### BRIEF DESCRIPTION OF THE DRAWINGS

The accompanying drawings, which are incorporated herein and constitute part of this specification, illustrate exemplary examples of the disclosure, and together with the general description given above and the detailed description given below, serve to explain the features of the various examples.

FIG. 1 is a schematic diagram of a communication system in accordance with various examples.

FIG. 2 is a component block diagram of a wireless communication device according to various examples.

FIG. 3A is a process flowchart diagram illustrating a method for supplementing wireless local area network (WLAN) connection of a wireless communication device according to various examples.

FIG. 3B is a schematic diagram illustrating an operation of aggregating WLAN data and WWAN data for a wireless communication device according to various examples.

FIG. 4 is a process flowchart diagram illustrating a method for supplementing WLAN connection of a wireless communication device according to various examples.

FIG. 5 is a component block diagram of a wireless communication device suitable for use with various examples.

### DETAILED DESCRIPTION

Various examples will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

A modern communication device, referred to herein as a wireless communication device, User Equipment (UE), or Mobile Station (MS), may include one or more of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that enable access to one or multiple separate mobile communication networks. The access to mobile communication networks may be facilitated by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more networks with one SIM being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one may be deactivated when the other one is in use. In another example, the MSMS communication device may be a Triple-SIM-Triple-Standby (TSTS) communication device, which includes three SIMs that may all be active on standby, where two may be deactivated when a third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more networks with two or more SIMs being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, examples described herein may be applicable to a MSMS wireless communication device having at least a first SIM and a second SIM. Illustrating with a non-limiting example, the first SIM may be associated with a first subscription, and the second SIM may be associated with a second subscription. Additionally or alternatively, the examples may be applicable to a MSMA wireless communication device having its first subscription influenced by activities (also referring to activity) of the second subscription due to interference, activity pattern, power back-off, and/or the like associated with the second subscription.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless communication device on a network and enable communication services with the network. A SIM as referred to herein may be a physical SIM, virtual SIM, soft SIM, or the like. Because the information stored in a SIM may be used to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

When wireless local area network (WLAN) (e.g., Wi-Fi) and wireless wide area network (WWAN) (e.g., 2G, 3G, 4G, 5G cellular network) are both available for data services, a wireless communication device may prioritize WLAN over WWAN due to the relatively low cost of data usage on WLAN. However, WLAN performance may degrade when the wireless communication device is far from the WLAN access point, the WLAN network is congested and/or interfered, and so on, thus resulting in poor user experience. Referring to the Figures generally, systems and methods are disclosed for supplementing WLAN connection of a wireless communication device with WWAN data when the WLAN speed is not optimal. As used herein, the term “WLAN” refers to any wireless technology for a local area network, such as but not limited to Wi-Fi, Bluetooth, WiMAX, etc. The term “Wi-Fi” refers to the wireless technology based on IEEE 802.11 standards, such as 802.11a/b/g/n/ac. Because Wi-Fi is by far the most widely used WLAN technology, terms “WLAN” and “Wi-Fi” can be used interchangeably in this disclosure. Terms “WWAN,” “cellular network,” and “mobile network” can be used interchangeably in this disclosure.

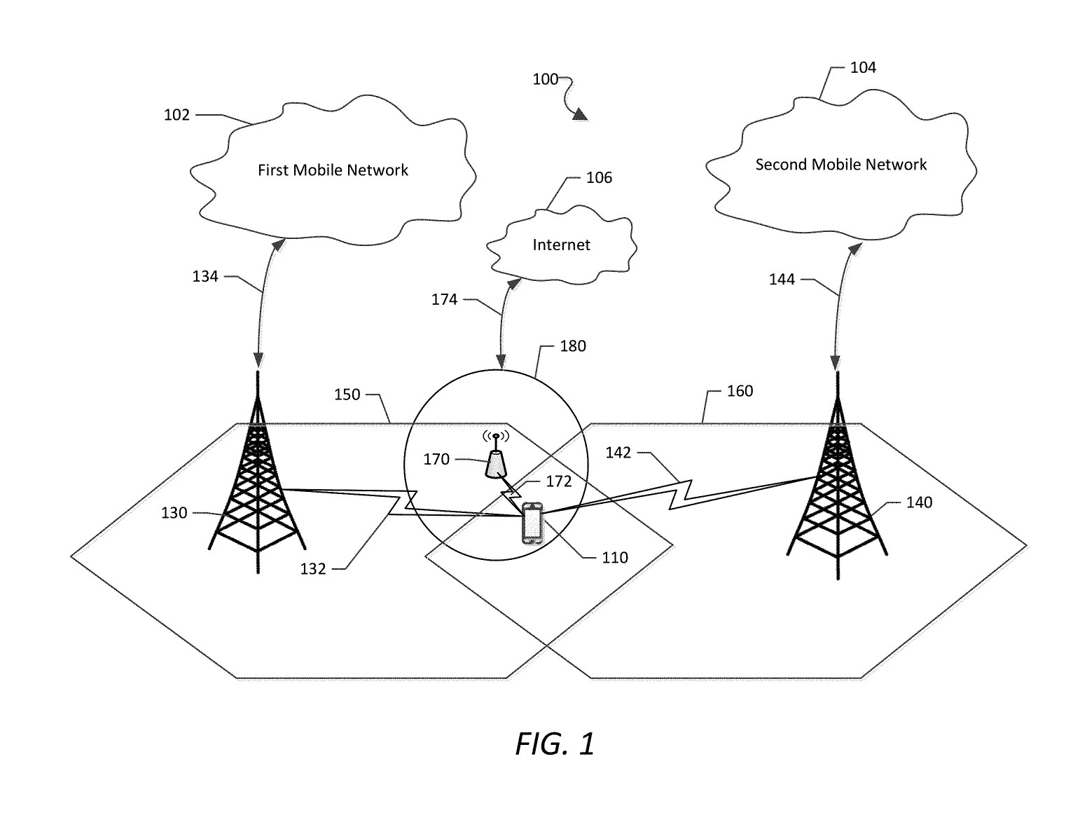

Various examples may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may enable the first mobile network 102 in a first serving cell 150. The second base station 140 may enable the second mobile network 104 in a second serving cell 160. A WLAN access point 170 may associate with Internet 106 and enable a wireless network (i.e., the WLAN) in a wireless coverage area 180. A wireless communication device 110 may be associated with (within effective boundaries of) both the first serving cell 150 and the second serving cell 160. The wireless communication device 110 may also be associated with the wireless coverage area 180.

The wireless communication device 110 may be in communication with the first mobile network 102 through a first cellular connection 132 to the first base station 130. The first cellular connection 132 may correspond to the first RAT of the wireless communication device 110. The wireless communication device 110 may be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144. The first mobile network 102 and the second mobile network 104 can include or connect to the Internet 106.

Each of the first cellular connection 132 and the second cellular connection 142 may be a two-way wireless communication link. Each wireless communication link may be enabled by any suitable protocol (RAT) including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 may be a LTE connection. The second cellular connection 142 may be a LTE, WCDMA, GSM or 1× connection. Other RATs (such as, but not limited to, HSDPA, EVDO, and the like) may be implemented in a similar manner.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some examples, each of the first base station 130 and the second base station 140 may be an access point, Node B, evolved Node B (eNodeB or eNB), base transceiver station (BTS), or the like.

In various examples, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted or otherwise provided, the wireless communication device 110 may access the mobile communication network associated with that RAT based on the information stored on the SIM through registrations and call setups, as described herein.

While the wireless communication device 110 is shown connected to the mobile networks 102 and 104 via two cellular connections, in other examples (not shown), the wireless communication device 110 may establish additional network connections using at least one additional RAT.

The wireless communication device 110 may also be in connection with the Internet 106 or another network through a wireless connection 172 to the WLAN access point 170. The access point 170 operates the WLAN and connects to the Internet 106 over a wired or wireless connection 174. The wireless connection 172 may be a two-way radio link enabled by IEEE 802.11 standards (e.g., 802.11a/b/g/n/ac). In some examples, Wi-Fi link operates in the 2.4 GHz and/or 5 GHz frequency bands of the electromagnetic spectrum associated with radio wave propagation. It should be understood that Wi-Fi is used here for illustration but not for limitation. Other WLAN technologies can be used to establish the WLAN, such as but not limited to Wi-Fi, Bluetooth, WiMAX, etc.

The WLAN access point 170 may include at least one antenna group associated with signal transmission and reception. The access point 170 may also include one or more processors, modulators, multiplexers, demodulators, demultiplexers, and the like for performing the functions described herein. In some examples, the WLAN access point 170 is a Wi-Fi modem/router, which may operate in various settings, such as but not limited to a residential setting as a home Wi-Fi network, a commercial/retail setting as a Wi-Fi hotspot, or a business/office setting as an enterprise Wi-Fi network. In various examples, the wireless communication device 110 may be configured to access the Internet 106 through the access point 170 by virtue of a WLAN interface of the wireless communication device 110 (e.g., via the wireless connection 172).

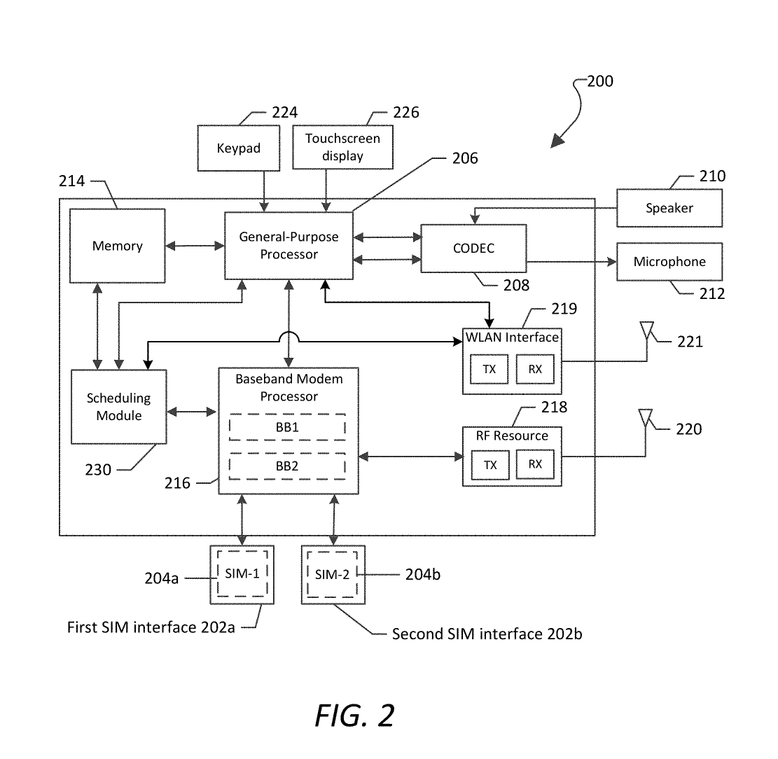

FIG. 2 is a functional block diagram of a wireless communication device 200 suitable for implementing various examples. According to various examples, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a (the first SIM) that is associated with the first mobile network 102 via a first RAT. The wireless communication device 200 may also include a second SIM interface 202b, which may receive a second identity module SIM-2 204b (the second SIM) that is associated with the second mobile network 104 via a second RAT. Although two SIM interfaces/modules are shown in FIG. 2 for the simplicity of illustration, it should be understood that the wireless communication device 200 may include more than two SIM interfaces/modules.

A SIM (e.g., SIM-1 204a, SIM-2 204b, and/or the like) in various examples may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have one or more of a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. In an example in which the SIM is a virtual SIM or soft SIM, a SIM may be implemented within a portion of memory of the wireless communication device 200, and thus need not be a separate or removable circuit, chip, or card.

A SIM used in various examples may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one WLAN interface 219, which includes a wireless receiver, transmitter, transceiver, and/or other elements that enable the wireless communication device 200 to access the Internet 106 through the WLAN access point 170 (e.g., via the wireless connection 172). In some examples, the WLAN interface 219 can be a peripheral component interconnect (PCI) adapter card or a built-in card integrating Wi-Fi and Bluetooth communication functions. The card may be identified by a unique wireless media access control (MAC) address, which can be used as a network address in accordance with, for example, the IEEE 802.11 standards. The WLAN interface 219 may use other WLAN technologies additionally or alternatively. The WLAN interface 219 is connected to at least one antenna 221 for transmitting and receiving radio signals to/from the WLAN access point 170. In some examples, the antenna 221 is tuned to transmit and receive signals in the 2.4 GHz and/or 5 GHz frequency bands in accordance with the IEEE 802.11 standards.

The wireless communication device 200 may include at least one controller, such as a general-purpose processor 206, which may be coupled to the WLAN interface 219. The general-purpose processor 206 may also be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may include a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The examples described herein may be applicable to wireless communication devices in which the SIMs 204a and 204b share a common set of RF resource (particularly, the RF resource 218). Examples described herein may be applicable to wireless communication devices in which each of the SIMs 204a and 204b is associated with a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b. The RF resource 218 may include separate transmit and receive circuitry, or may include a transceiver that combines transmitter and receiver functions. The RF resource 218 may be coupled to a wireless antenna 220. The RF resource 218 may be coupled to the baseband modem processor 216.

In various examples, at least one of the first and second subscriptions may be set as a designated data service (DDS) subscription, through which data services are provided for the wireless communication device 200. For example, if the first subscription is set as the DDS subscription, the first SIM 204a may register both the circuit switched (CS) domain for voice calls and the packet switched (PS) domain for data services. If the second subscription is set as the non-DDS subscription, the second SIM 204b may register the CS domain for voice calls but not register the PS domain for data services.

In some examples, the general-purpose processor 206, the memory 214, the baseband modem processor 216, the RF resource 218, and the WLAN interface 219 may be included in the wireless communication device 200 as a system-on-chip. In some examples, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. In some examples, the touchscreen display 226 may receive a request to designate at least one of the first and second subscriptions as the DDS subscription. Interfaces may be provided between the various software modules and functions in the wireless communication device 200 to enable communications therebetween.

The wireless communication device 200 may include a scheduling module 230 capable of performing the functions described herein with respect to scheduling activities of the first subscription, the second subscription, and the WLAN connection. The scheduling module 230 may communicate with the software layers corresponding to the first subscription, the second subscription, and the WLAN connection. Particularly, the scheduling module 230 may communicate with the software layer corresponding to the WLAN connection to obtain information on performance of the WLAN connection. The scheduling module 230 may use the information to schedule activities on the first and/or the second subscription in the manner described herein.

In some examples, the scheduling module 230 may be implemented within the general-purpose processor 206. For example, the scheduling module 230 may be implemented as a software application stored within the memory 214 and executed by the general-purpose processor 206. Accordingly, such examples can be implemented with minimal additional hardware costs. However, other examples relate to systems and processes implemented with dedicated hardware specifically configured for performing operations described herein with respect to the scheduling module 230. For example, the scheduling module 230 may be implemented as a separate processing component (i.e., separate from the general-purpose processor 206). The scheduling module 230 may be coupled to the memory 214, the general processor 206, the baseband processor 216, the RF resource 218, and the WLAN interface 219 for performing the function described herein.

Hardware and/or software for the functions may be incorporated in the wireless communication device 200 during manufacturing, for example, as a part of a configuration of an original equipment manufacturer (OEM) of the wireless communication device 200. In further examples, such hardware and/or software may be added to the wireless communication device 200 post-manufacture, such as by installing one or more hardware devices and/or software applications onto the wireless communication device 200.

In some examples, the wireless communication device 200 may include, among other things, to additional SIMs, SIM interfaces, at least another RF resource associated with the additional SIMs, and additional antennas for connecting to additional mobile networks.

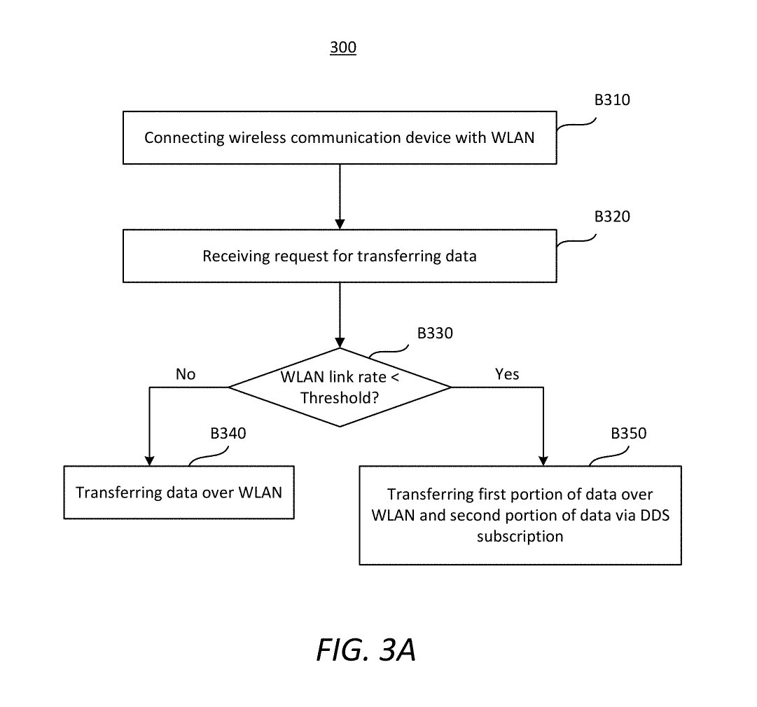

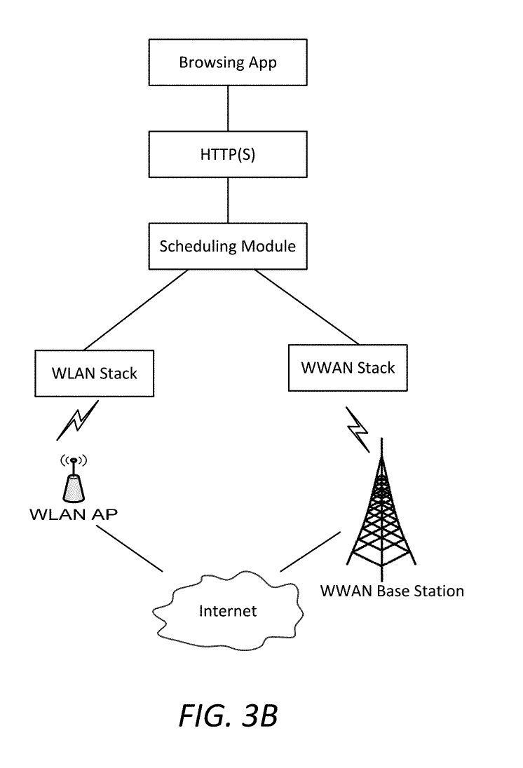

FIG. 3A is a process flowchart diagram illustrating a method 300 for supplementing WLAN communication according to various examples. Referring to FIGS. 1-3, in some examples, the wireless communication device 200 is connected with a WLAN, at block B310. In various examples in which the WLAN access point 170 is a Wi-Fi router/modem/hotspot, the access point 170 broadcasts its unique service set identifier (SSID) in a radio signal. Upon entering the wireless coverage area 180 associated with the access point 170, the wireless communication device 200 can detect the SSID broadcast by the access point 170. The wireless communication device 200 actively scans for available WLAN by sending a probe request, which includes the SSID of the access point 170, the wireless MAC address of the wireless communication device 200, and information needed for communication such as data rates and 802.11 capabilities supported by the wireless communication device 200. If the access point 170 has at least one compatible data rate with the wireless communication device 200, the access point 170 sends out a probe response advertising supported data rates, other 802.11 capabilities, and encryption types of the access point 170 if applicable.

The wireless communication device 200 then sends an authentication request to the WLAN access point 170. There may be a variety of authentication types, such as but not limited to, open authentication (i.e., no authentication), wired equivalent privacy (WEP), Wi-Fi protected access (WPA), WPA II pairwise transient key (WPA2-PSK), and so on. The access point 170 sends an authentication response indicating the success or failure of the authentication. If the authentication is successful, the wireless communication device 200 sends an association request to the access point 170 requesting to join the WLAN associated with the access point 170. The access point 170 sends an association response acknowledging or declining the association request. The wireless communication device 200 joins the WLAN upon acknowledgement by the access point 170.

In some examples, the wireless communication device 200 sends a dynamic host configuration protocol (DHCP) request over the newly joined WLAN for obtaining an Internet protocol (IP) address. A DHCP server, which typically is the access point 170, grants an IP address to the wireless communication device 200 and provides network configuration information, such as the subnet mask, the default gateway for transferring IP packets beyond the WLAN and the default domain name server (DNS) for translating web addresses into IP addresses. The default DHCP server and DNS may both be the access point 170. Once the IP address is obtained, the wireless communication device 200 is connected to the Internet 106 and ready to transfer data over the Internet 106. It should be understood that the process of establishing the Wi-Fi connection is illustrated as an example not for limitation; any suitable process of establishing WLAN can be implemented.

At block B320, a request for transferring data is received. The request may be received at the keypad 224, the touchscreen display 226, or a combination thereof. For example, a user of the wireless communication device 200 may open an Internet browsing application and enter a website address using the touchscreen display 226 and/or the keypad 224. The user may further download/upload files (e.g., image, audio, video, etc.) from/to the website using the touchscreen display 226 and/or the keypad 224. In another example, the user may open an email application and receive/send emails using the keypad 224 and/or the touchscreen display 226. In yet another example, the user may open an application (e.g., whether application, stock application, etc.) using the touchscreen display 226 and/or the keypad 224, which obtains information over the Internet 106. As discussed, the request may include uplink data transmission from the wireless communication device 200 to the Internet 106 (e.g., a remote Internet service provider), and/or downlink transmission from the Internet 106 to the wireless communication device 200. It should be understood that these examples are for illustration and not for limitation; the request for transferring data can be received in any suitable manner.

At block B330, it is determined whether a WLAN link rate for the wireless communication device 200 is less than a link rate threshold. In some examples, the WLAN link rate is monitored by WLAN interface 219, the link rate threshold is a predefined value stored in memory 214, and the determination is performed by the scheduling module 230 and/or the general-purpose processor 206.

As used herein, the term “WLAN link rate” refers to the available data rate across the wireless connection between the wireless communication device 200 and the WLAN access point 170. The WLAN link rate may be the available transmission rate from the access point 170 to the wireless communication device 200, the available transmission rate from the wireless communication device 200 to the access point 170, or a combination thereof. Wi-Fi 820.11b supports a nominal link rate of 11 Mbps, 802.11a supports a nominal rate of 54 Mbps, 820.11g supports a nominal rate of 54 Mbps for single wide channel and 108 Mbps for double wide channel, 802.11n supports a nominal rate of 72.2 Mbps for single wide channel and 150 Mbps for double wide channel, and so on. However, the nominal rates might not be achieved in practice due to various reasons. In particular, Wi-Fi network is a shared network; the more devices connected to the access point 170, the less data rate each device is able to get. In addition, the strength of the radio signal decreases with the distance between the WLAN access point 170 and the wireless communication device 200. The further the wireless communication device 200 is away from the access point 170, the weaker the radio signal and the slower the link rate. Furthermore, building materials near the access point 170 may absorb or reflect radio waves, interfering with the data transmission. Thus, the practically available WLAN link rate may be substantially lower than the nominal rates when the WLAN is congested and/or interfered, and/or when the wireless communication device 200 is close to the edge of the wireless coverage area 180.

In various examples, the WLAN link rate is estimated by passively monitoring the data transmission between the wireless communication device 200 and the WLAN access point 170. For example, the throughput of data received and/or transmitted at the WLAN interface 219 may be monitored during a period of time (e.g., 1 second, 2 seconds, 3 seconds, etc.). The WLAN link rate may be the average data rate for the period of time. The WLAN link rate may be updated on a real time basis or periodically (e.g., every 30 seconds, every minute, every 2 minutes, etc.) This passive scheme can provide an accurate estimation of the available data rate on the WLAN and can be fast adaptive to varying link rates. It should be understood that the process for estimating the WLAN link rate is described herein for illustration but not for limitation, any suitable process can be used to determine the WLAN link rate.

In various examples, the link rate threshold is a predefined value stored in the memory 21. The value may be chosen based on, for example but not limited to, tests and/or past experiences for achieving an optimal user experience. In further examples, the link rate threshold may vary with the size of data requested for transferring. For instance, a higher link rate threshold may be set for browsing a webpage with high content (e.g., webpage of Wall Street Journal), while a lower link rate threshold may be set for browsing a webpage with low content (e.g., webpage of Wikipedia).

In response to determining that the WLAN link rate for the wireless communication device 200 is not less than the link rate threshold (B330: No), the data requested for transferring is transferred over the WLAN, at block B340. In various examples, the scheduling module 230 and/or the general-purpose process 206 may arrange the data to be transferred via the WLAN interface 219. As discussed above with reference to block B310, the wireless communication device 200 may be granted an IP address and provided with network configuration information (e.g., DHCP server, gateway, DNS, etc.) when being connected to the WLAN. Upon receiving a uniform resource location (URL) address in the web browser, the wireless communication device 200 may use the DNS to translate the URL address into a corresponding IP address and use the gateway to transfer IP packets beyond the WLAN.

In response to determining that the WLAN link rate for the wireless communication device 200 is less than the link rate threshold (B330: Yes), a first portion of the data is transferred over the WLAN and a second portion of the data is transferred via a DDS subscription, at block B350. In various examples, the scheduling module 230 and/or the general-purpose process 206 may arrange the first portion of data to be transferred via the WLAN interface 219 and the second portion of data to be transferred via at least one SIM interface (e.g., 204a and/or 204b) associated with the DDS subscription. As discussed above with reference to FIG. 2, at least one subscription can be set as the DDS subscription, through which data services are provided for the wireless communication device 200. It is assumed for the discussion herein that the first subscription associated with the first SIM module 204a is set as the DDS subscription while the second subscription associated with the second SIM module 204b is set as the non-DDS subscription. It should be understood that more than one subscriptions may be set as the DDS subscription. In various examples, parallel connections for transferring data are opened on both the WLAN and the first subscription (i.e., the DDS subscription) associated with the first mobile network 102. The first portion of data is transferred through the connections opened on the WLAN and the second portion of data is transferred through the connections opened on the first subscription. Webpage browsing is taken as an example herein for illustration. FIG. 3B is a schematic diagram illustrating the operation of block B350 in the context of webpage browsing according to various examples. A user of the wireless communication device 200 opens a web browsing app executed by the general-purpose processor 206 for browsing a webpage. The web browser uses the hypertext transfer protocol (HTTP) to request a remote server (not shown) that operates the webpage to load the webpage to the wireless communication device 200. Besides text, the webpage may contain a plurality of embedded objects, such as but not limited to, images, animations, audios, and/or videos. HTTP allows a client device (i.e., the wireless communication device 200) to open multiple connections and perform HTTP transactions in parallel, with each transaction having a corresponding connection. The composite webpage containing embedded objects may load faster by taking advantage of parallel connections. In some examples, the general-purpose processor 206 and/or the scheduling module 230 opens one connection on the WLAN to load a first set of embedded objects of the webpage. Through the connection on the WLAN, the first set of embedded objects can be transmitted from the remote server to the WLAN access point (e.g., the WLAN access point 170) through the Internet, then from the WLAN access point to the wireless communication device 200 through the WLAN Stack (e.g., the WLAN interface 219). The general-purpose processor 206 and/or the scheduling module 230 opens one parallel connection on the WWAN (e.g., the first mobile network 102) to load a second set of embedded objects of the webpage. Through the connection on the WWAN, the second set of embedded objects can be transmitted from the remote server to the WWAN base station (e.g., the first base station 130) through the Internet, then from the WWAN base station to the wireless communication device 200 through the WWAN Stack (e.g., the DDS subscription). In some examples, more than one parallel connections are opened on the WLAN and/or more than one parallel connections are opened on the WWAN.

In further examples, the first portion of data and the second portion of data are so arranged that a sum of the WLAN link rate and the first mobile network link rate crosses the predefined link rate threshold for an optimal user experience. In particular, the general-purpose processor 206 and/or the scheduling module 230 may open one or more connections on the WLAN to utilize the available WLAN link rate. As discussed above with reference to block B330, the WLAN link rate may be estimated by passively monitoring the throughput of data received and/or transmitted at the WLAN interface 219 during a period of time. The general-purpose processor 206 and/or the scheduling module 230 may open one or more connections on the first mobile network 102 to make up the difference between the WLAN link rate and link rate threshold. The link rate of the first mobile network 102 may be estimated by monitoring throughput of data received and/or transmitted at the first SIM interface 202a during a period of time. If the link rate of the first mobile network 102 has not met the difference, more parallel connections may be opened on the first mobile network 102 to load additional embedded objects. If the link rate of the first mobile network 102 has met the difference, the general-purpose processor 206 and/or the scheduling module 230 may stop opening new connections on the first mobile network 102.

As described, the method 300 can achieve a load balance across WLAN and mobile networks in a distributed manner without a centralized scheme by the network. None of the operations at blocks B310 through B350 requires modifications to the mobile networks or the server/proxy. Rather, all operations of the method 300 can be self-contained within the wireless communication device 200. In addition, the method 300 can be compatible with any RATs for the mobile networks (e.g., 2G, 3G, 4G, 5G) because the WLAN and the mobile network are used independently to transfer data. Furthermore, user experience can be enhanced and at the same time, the WLAN bandwidth can be well utilized. User experience is improved by adaptively supplementing poor WLAN link with data usage on the mobile network, which is limited to what is needed for an optimal user experience. In other words, the wireless communication device 200 “sips” bandwidth from the mobile networks only to the extent to meet a predefined link rate for an optimal user experience.

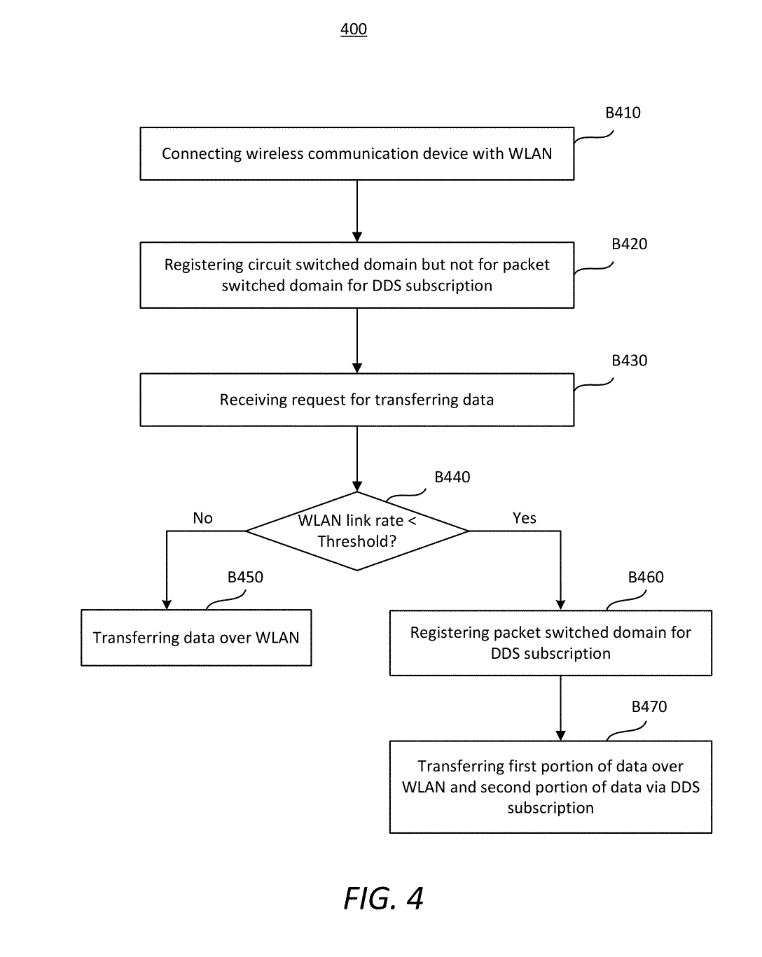

FIG. 4 is a process flowchart diagram illustrating a method 300 for supplementing WLAN communication according to various examples. Referring to FIGS. 1-4, one or more of blocks B410-B470 may correspond to one of blocks B310-B350.

At block B410, the wireless communication device 200 is connected with a WLAN. As discussed with reference to block B310 of FIG. 3A, once the connection with the WLAN access point 170 is established, the wireless communication device 200 may not only transmit and receive data to/from the access point 170, but also transfer data over the Internet 106 through the WLAN operated by the access point 170.

At block B420, a circuit switched (CS) domain is registered for a DDS subscription but a packet switched (PS) domain is not registered for the DDS in response to the connection at block B410. As discussed above with reference to FIG. 2, at least one of the first and second subscriptions can be set as the DDS subscription, through which data services are provided for the wireless communication device 200. It is assumed for the discussion herein that the first subscription associated with the first SIM module 204a is set as the DDS subscription while the second subscription associated with the second SIM module 204b is set as the non-DDS subscription. It should be understood that more than one subscriptions may be set as the DDS subscription.

Typically, the DDS subscription may register both the CS domain for voice calls and the PS domain for data services while the non-DDS subscription may register only the CS domain but not the PS domain. As used herein, CS domain registration refers to a “location update procedure,” in which the wireless communication device 200 informs the mobile network (e.g., a base station of the mobile network) of its identity (SIM serial number associated with the subscription) for voice calls. The CS domain registration may be performed periodically or upon the wireless communication device 200 entering a space with a new location identifier. As used herein, PS domain registration refers to a “routing area update procedure,” in which the wireless communication device 200 informs the mobile network of its identity for data services. The PS domain registration may be performed periodically or upon the wireless communication device entering a space with a new routing area identifier.

At block B420, the DDS subscription only registers the CS domain but not the PS domain because the WLAN connection has been established for data services and the DDS subscription may be used for voices calls only. By skipping the PS registration for the DDS subscription, the wireless communication device 200 can save substantial amount of power and network resources. In particular, paging channel (PCH) signaling can be avoided and discontinuous reception (DRX) cycle can be shorter, yielding substantial power saving. In addition, data driven activities such as but not limited to absolute priority searches can be dropped, resulting in further savings of power and network resources.

At block B430, a request for transferring data is received. As discussed with reference to block B320 of FIG. 3A, the request may be received at the keypad 224, the touchscreen display 226, or a combination thereof.

At block B440, it is determined whether a WLAN link rate for the wireless communication device 200 is less than a link rate threshold. As discussed with reference to block B330 of FIG. 3A, the WLAN link rate may be estimated by passively monitoring the throughput of data received and/or transmitted at the WLAN interface 219 during a period of time. The link rate threshold may be a predefined value stored in memory 214, which corresponds to an optimal user experiences based on tests and/or past experiences. In some examples, the link rate threshold may vary with the size of data requested for transferring. The scheduling module 230 and/or the general-purpose processor 206 may determine whether the WLAN link rate is less than the link rate threshold.

In response to determining that the WLAN link rate for the wireless communication device 200 is not less than the link rate threshold (B440: No), the data requested for transferring is transferred over the WLAN, at block B450. As discussed with reference to block B340 of FIG. 3A, the scheduling module 230 and/or the general-purpose process 206 may arrange the data to be transferred via the WLAN interface 219.

In response to determining that the WLAN link rate for the wireless communication device 200 is less than the link rate threshold (B440: Yes), the PS domain is registered for the DDS subscription, at block B460. As discussed above with reference to block B420, the DDS subscription stopped PS domain registration to save power and network resources in response to the wireless communication device 200 being connected to the WLAN for data services. However, if the WLAN link rate is low, the data capacity on the DDS subscription may be brought back through PS registration.

In particular, if the RAT associated with data services on the DDS subscription involves GPRS, the PS registration may include a GPRS attach procedure and a packet data protocol (PDP) context activation procedure. In the GPRS attach procedure, a logical link is established between the wireless communication device 200 and a gateway for accessing the Internet. In the PDP context activation procedure, an IP address is allocated to the wireless communication device 200, which can be used for transferring data over the Internet. The PDP context may also specify the network configuration such as quality of service (QoS) parameters. If the RAT associated with data services on the DDS subscription involves LTE, PS registration may include a LTE attach and evolved packet system (EPS) bearer setup procedure, during which the mobile network obtains the mobile equipment identity from the wireless communication device 200 and a default EPS bearer with a nominal QoS is established. In some examples, one or more dedicated EPS bearer may be established for specific traffic of the wireless communication device 200 in the PS registration. It should be understood that the RATs of GPRS and LTE are given herein for illustration but not for limitation. Any suitable RAT can be associated with data services on the DDS subscription; and corresponding PS registration can be implemented.

At block B470, a first portion of the data is transferred over the WLAN and a second portion of the data is transferred via a DDS subscription. As discussed above with reference to block B350 of FIG. 3A, the scheduling module 230 and/or the general-purpose process 206 may arrange the first portion of data to be transferred via the WLAN interface 219 and the second portion of data to be transferred via at least one SIM interface (e.g., 204a and/or 204b) associated with the DDS subscription. In various examples, parallel connections for transferring data are opened on both the WLAN and the first mobile network 102 associated with the first subscription (i.e., the DDS subscription). The first portion of data is transferred through the connections opened on the WLAN and the second portion of data is transferred through the connections opened on the first mobile network 102. In further examples, the first portion of data and the second portion of data are so arranged that a sum of the WLAN link rate and the first mobile network link rate crosses the predefined link rate threshold for an optimal user experience.

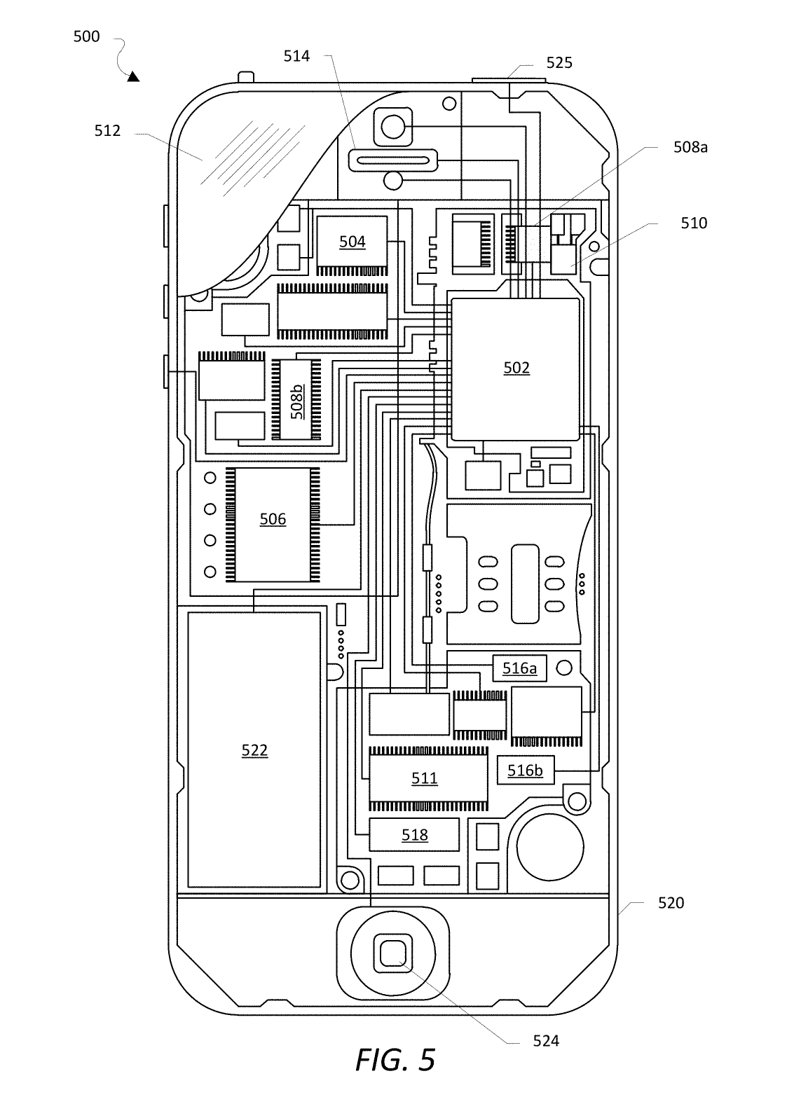

The various examples may be implemented in any of a variety of wireless communication devices 110 and 200, an example of which is illustrated in FIG. 5, as a wireless communication device 500. As such, the wireless communication device 900 may implement the process and/or the apparatus of FIGS. 1-4, as described herein.

With reference to FIGS. 1-5, the wireless communication device 500 may include a processor 502 coupled to a touchscreen controller 504 and an internal memory 506. The processor 502 may be one or more multi-core integrated circuits designated for general or specific processing tasks. The memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the wireless communication device 500 need not have touch screen capability.

The wireless communication device 500 may have one or more cellular network transceivers 508a, 508b coupled to the processor 502 and to at least one antenna 510 and configured for sending and receiving cellular communications. The transceivers 508a, 508b and antenna 510 may be used with the above-mentioned circuitry to implement the various example methods. The cellular network transceivers 508a, 508b may be the RF resource 218. The antenna 510 may be the antenna 220. The wireless communication device 500 may include two or more SIM cards 516a, 516b, corresponding to SIM-1 204a and SIM-2 204b (respectively), coupled to the transceivers 508a, 508b and/or the processor 502. The wireless communication device 500 may include a cellular network wireless modem chip 511 (e.g., the baseband modem processor 216) that enables communication via at least one cellular network and is coupled to the processor 502.

The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. For example, the peripheral device connection interface 518 may also be coupled to the WLAN interface 219.

The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to a peripheral device connection port (not shown) to receive a charging current from a source external to the wireless communication device 500. The wireless communication device 500 may also include a physical button 524 for receiving user inputs. The wireless communication device 500 may also include a power button 526 for turning the wireless communication device 500 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present invention. Various modifications to these examples will be readily apparent to those skilled in the art, and the generic principles defined herein may be applied to some examples without departing from the spirit or scope of the invention. Thus, the present invention is not intended to be limited to the examples shown herein but is to be accorded the widest scope consistent with the following claims and the principles and novel features disclosed herein.

What is claimed is:

1. A method for a wireless communication device having multiple Subscriber Identity Modules (SIMs) in which at least one of the SIMs is associated with a Designated Data Service (DDS) subscription, the method comprising:
connecting the wireless communication device with a wireless local area network (WLAN);
receiving a request for transferring data;
determining whether a WLAN link rate of the wireless communication device is less than a link rate threshold; and
transferring a first portion of the data over the WLAN and a second portion of the data via the DDS subscription in response to determining that the WLAN link rate is less than the link rate threshold.

2. The method of claim 1, further comprising transferring the data over the WLAN in response to determining that the WLAN link is not less than the link rate threshold.

3. The method of claim 1, wherein the WLAN is a Wi-Fi network, a Bluetooth network, or a WiMAX network.

4. The method of claim 1, wherein the link rate threshold is predefined.

5. The method of claim 1, wherein the link rate threshold varies with a size of the data requested for transferring.

6. The method of claim 1, further comprising:
passively monitoring a data throughput at a WLAN interface of the wireless communication device during a period of time; and
determining the WLAN link rate based on the monitored data throughput during the period of time.

7. The method of claim 1, further comprising:
opening one or more connections on the WLAN;
transferring the first portion of data through the one or more connections opened on the WLAN;
opening one or more parallel connections on the DDS subscription; and
transferring the second portion of data through the one or more parallel connections opened on the DDS subscription.

8. The method of claim 1, wherein the first portion of data and the second portion of data are so arranged that a sum of the WLAN link rate and a link rate of the DDS subscription crosses the link rate threshold.

9. A method for a wireless communication device having multiple Subscriber Identity Modules (SIMs) in which at least one of the SIMS is associated with a Designated Data Service (DDS) subscription, the method comprising:
connecting the wireless communication device with a wireless local area network (WLAN);
registering a circuit switched (CS) domain for the DDS subscription but not a packet switched (PS) domain in response to the connecting;
receiving a request for transferring data;
determining whether a WLAN link rate of the wireless communication device is less than a link rate threshold;
registering the PS domain for the DDS subscription in response to determining that the WLAN link rate is less than the link rate threshold; and
transferring a first portion of the data over the WLAN and a second portion of the data via the DDS subscription.

10. The method of claim 9, further comprising transferring the data over the WLAN in response to determining that the WLAN link is not less than the link rate threshold.

11. The method of claim 9, further comprising:
passively monitoring a data throughput at a WLAN interface of the wireless communication device during a period of time; and
determining the WLAN link rate based on the monitored data throughput during the period of time.

12. The method of claim 9, further comprising:
opening one or more connections on the WLAN;
transferring the first portion of data through the one or more connections opened on the WLAN;
opening one or more parallel connections on the DDS subscription; and
transferring the second portion of data through the one or more parallel connections opened on the DDS subscription.

13. The method of claim 9, wherein the first portion of data and the second portion of data are so arranged that a sum of the WLAN link rate and a link rate of the DDS subscription crosses the link rate threshold.

14. The method of claim 9, wherein the link rate threshold is predefined.

15. A wireless communication device, comprising:
multiple Subscriber Identity Modules (SIMs) in which at least one of the SIMs is associated with a Designated Data Service (DDS) subscription;
a wireless local area network (WLAN) interface;
a memory configured to store a link rate threshold;
a processor coupled to the multiple SIMs, the WLAN interface, and the memory, the processor configured to:
connect the wireless communication device with a WLAN through the WLAN interface;
receive a request for transferring data;
determine whether a WLAN link rate of the wireless communication device is less than the link rate threshold; and
transfer a first portion of the data over the WLAN and a second portion of the data via the DDS subscription in response to determining that the WLAN link rate is less than the link rate threshold.

16. The wireless communication device of claim 15, wherein the processor is further configured to transfer the data over the WLAN in response to determining that the WLAN link is not less than the link rate threshold.

17. The wireless communication device of claim 15, wherein the WLAN is a Wi-Fi network, a Bluetooth network, or a WiMAX network.

18. The wireless communication device of claim 15, wherein the link rate threshold is predefined.

19. The wireless communication device of claim 15, wherein the link rate threshold varies with a size of the data requested for transferring.

20. The wireless communication device of claim 15, wherein the processor is further configured to:
passively monitor a data throughput transmitted and/or received at the WLAN interface during a period of time; and
determine the WLAN link rate based on the monitored data throughput during the period of time.

21. The wireless communication device of claim 15, wherein the processor is further configured to:
open one or more connections on the WLAN;
transfer the first portion of data through the one or more connections opened on the WLAN;
open one or more parallel connections on the DDS subscription; and
transfer the second portion of data through the one or more parallel connections opened on the DDS subscription.

22. The wireless communication device of claim 15, wherein the first portion of data and the second portion of data are so arranged that a sum of the WLAN link rate and a link rate of the DDS subscription crosses the link rate threshold.

23. The wireless communication device of claim 15, wherein the processor is further configured to:
register a circuit switched (CS) domain for the DDS subscription but not a packet switched (PS) domain in response to the connecting; and
register the PS domain for the DDS subscription in response to determining that the WLAN link rate is less than the link rate threshold.

24. A non-transitory computer-readable medium having processor-readable instruction such that, when executed, causes a processor to perform a method for a wireless communication device having multiple Subscriber Identity Modules (SIMs) in which at least one of the SIMs is associated with a Designated Data Service (DDS) subscription, the method comprising:
connecting the wireless communication device with a wireless local area network (WLAN);
receiving a request for transferring data;
determining whether a WLAN link rate of the wireless communication device is less than a link rate threshold; and
transferring a first portion of the data over the WLAN and a second portion of the data via the DDS subscription in response to determining that the WLAN link rate is less than the link rate threshold.

25. The non-transitory computer-readable medium of claim 24, wherein the method further comprises transferring the data over the WLAN in response to determining that the WLAN link is not less than the link rate threshold.

26. The non-transitory computer-readable medium of claim 24, wherein the link rate threshold is predefined.

27. The non-transitory computer-readable medium of claim 24, wherein the method further comprises:
passively monitoring a data throughput transmitted and/or received at the WLAN interface during a period of time; and
determining the WLAN link rate based on the monitored data throughput during the period of time.

28. The non-transitory computer-readable medium of claim 24, wherein the method further comprises:
opening one or more connections on the WLAN;
transferring the first portion of data through the one or more connections opened on the WLAN;
opening one or more parallel connections on the DDS subscription; and
transferring the second portion of data through the one or more parallel connections opened on the DDS subscription.

29. The non-transitory computer-readable medium of claim 24, wherein the first portion of data and the second portion of data are so arranged that a sum of the WLAN link rate and a link rate of the DDS subscription crosses the link rate threshold.

30. The non-transitory computer-readable medium of claim 24, wherein the method further comprises:
registering a circuit switched (CS) domain for the DDS subscription but not a packet switched (PS) domain in response to the connecting; and
registering the PS domain for the DDS subscription in response to determining that the WLAN link rate is less than the link rate threshold.
